(19) United States
(12) Patent Application Publication
(10) Pub. No.: US 2021/0240037 A1
(43) Pub. Date: Aug. 5, 2021

(54) LIQUID CRYSTAL DISPLAY DEVICE

(71) Applicant: NITTO DENKO CORPORATION, Ibaraki-shi, Osaka (JP)

(72) Inventors: Mariko Hirai, Ibaraki-shi (JP); Hiroyuki Takemoto, Ibaraki-shi (JP); Jin Yoshikawa, Ibaraki-shi (JP); Masanori Otsuka, Ibaraki-shi (JP)

(73) Assignee: NITTO DENKO CORPORATION, Ibaraki-shi, Osaka (JP)

(21) Appl. No.: 17/050,638

(22) PCT Filed: Apr. 12, 2019
(86) PCT No.: PCT/JP2019/015927

§ 371 Date: Oct. 26, 2020

(30) Foreign Application Priority Data
Apr. 27, 2018 (JP) 2018-087504

(51) Int. Cl. G02F 1/1335; G02F 1/1347; G02F 1/1343

(52) U.S. Cl. CPC G02F 1/133531; G02F 1/133504; G02F 1/134363; G02F 1/133524; G02F 1/134372; G02F 1/1347

(57) ABSTRACT

The liquid crystal display apparatus of the present invention includes: a liquid crystal panel, a viewer-side polarizing plate arranged on the viewer side of the liquid crystal cell, and a back surface-side polarizing plate, a light control layer and a surface light source device including a light source unit and a light guide plate configured to cause light from the light source unit to enter from a side surface, and to emit the light from a viewer-side surface opposed to the light control layer, wherein the surface light source device is configured to emit light which has directivity in an approximately normal direction of the viewer-side surface, and which contains a linearly polarized light component that vibrates in a plane approximately parallel to a light guide direction of light of the light guide plate at a high ratio, and wherein the linearly polarized light component has a vibration direction.

### TECHNICAL FIELD

The present invention relates to a liquid crystal display apparatus.

### BACKGROUND ART

Typically, liquid crystal display apparatus are required to have a wide viewing angle when used in scenes where a viewer position is not fixed and the apparatus are viewed from every angle (for example, in electronic advertisement and in television sets and personal computers for normal uses). To accomplish a wide viewing angle, various technologies using a diffusion sheet, a prism sheet, a wide viewing angle liquid crystal panel, a wide viewing angle polarizing plate, and the like are being investigated. Meanwhile, liquid crystal display apparatus capable of displaying an image at a narrow viewing angle (for example, liquid crystal display apparatus for use in cellular phones, notebook computers used in public places, automated teller machines, and seat monitors on rides) are also required for the prevention of screen peeking and other purposes when the viewer position is limited within a narrow range.

Further, in recent years, along with the frame narrowing and thinning of a display screen, a configuration in which LED light sources are arranged along one side of the display screen (for example, along a long side direction) has become mainstream, and it is also required to sufficiently narrow the viewing angle in a direction parallel to the array direction of the LED light sources at the time of narrow viewing angle setting.

In order to satisfy the above-mentioned requirement, as a liquid crystal display apparatus capable of switching between a wide viewing angle and a narrow viewing angle and narrowing the viewing angle in a direction parallel to the array direction of the LED light sources at the time of narrow viewing angle setting, there has been proposed a liquid crystal display apparatus including a backlight unit including a prism sheet, a louver film, a transparent/scattering switching element, and a liquid crystal panel in the stated order toward a viewer side (for example, Patent Literature 1).

### CITATION LIST

### Patent Literature

[PTL 1] JP 4311366 B2

### SUMMARY OF INVENTION

### Technical Problem

The louver film can control a viewing angle by blocking apart of incident light (in particular, light having a large incident angle). However, the use of the louver film is not preferred from the viewpoint of low power consumption because the transmittance in a front direction is also decreased. In addition, the louver film may cause interference unevenness with pixels. Further, as a problem common to the general liquid crystal display apparatus, there is a problem of thinning.

The present invention has been made in order to solve the above-mentioned problems inherent in the related art, and an object of the present invention is to provide a liquid crystal display apparatus which is capable of switching between a wide viewing angle and a narrow viewing angle without using a louver film, and is also capable of practically sufficiently narrowing the viewing angle in a direction parallel to the array direction of light sources at the time of narrow viewing angle setting.

### Solution to Problem

According to one embodiment of the present invention, there is provided a liquid crystal display apparatus, including in an order from a viewer side: a liquid crystal panel including a liquid crystal cell, a viewer-side polarizing plate arranged on the viewer side of the liquid crystal cell, and aback surface-side polarizing plate arranged on an opposite side to the viewer side of the liquid crystal cell; a light control layer configured to enable a scattering state of transmitted light to be changed; and a surface light source device including a light source unit and a light guide plate configured to cause light from the light source unit to enter from a side surface opposed to the light source unit, and to emit the light from a viewer-side surface opposed to the light control layer. In the liquid crystal display apparatus, the surface light source device is configured to emit light which has directivity in an approximately normal direction of the viewer-side surface, and which contains a linearly polarized light component that vibrates in a plane approximately parallel to a light guide direction of light of the light guide plate at a high ratio, and a vibration direction of the linearly polarized light component is approximately parallel to a transmission axis of the back surface-side polarizing plate.

In one embodiment, a driving mode of the liquid crystal cell is an IPS mode or an FFS mode.

In one embodiment, the light control layer includes: a first transparent substrate; a first transparent electrode layer; a composite layer of a polymer matrix and a liquid crystal compound; a second transparent electrode layer; and a second transparent substrate in the stated order, and the first transparent substrate and the second transparent substrate are each formed of a material containing a cycloolefin-based resin.

In one embodiment, the light guide plate has a principal surface having an approximately rectangular shape, and the light guide plate has a side surface opposed to the light source unit, the side surface being a side surface on a long side.

In one embodiment, the light control layer includes: a first transparent substrate; a first transparent electrode layer; a composite layer of a polymer matrix and a liquid crystal compound; a second transparent electrode layer; and a second transparent substrate in the stated order, the first transparent substrate has a front retardation of 50 nm or less, and the second transparent substrate has a front retardation of 50 nm or less.

In one embodiment, the light control layer includes: a first transparent substrate; a first transparent electrode layer; a composite layer of a polymer matrix and a liquid crystal compound; a second transparent electrode layer; and a second transparent substrate in the stated order, the first transparent substrate has a front retardation of more than 50 nm, and a slow axis of the first transparent substrate is substantially perpendicular or substantially parallel to a transmission axis of the viewer-side polarizing plate.

In one embodiment, the light control layer includes: a first transparent substrate; a first transparent electrode layer; a composite layer of a polymer matrix and a liquid crystal compound; a second transparent electrode layer; and a second transparent substrate in the stated order, the second transparent substrate has a front retardation of more than 50 nm, and a slow axis of the second transparent substrate is substantially perpendicular or substantially parallel to a transmission axis of the viewer-side polarizing plate.

In one embodiment, the first transparent substrate has a front retardation of more than 50 nm, the second transparent substrate has a front retardation of more than 50 nm, and the slow axis of the first transparent substrate is substantially perpendicular or substantially parallel to the slow axis of the second transparent substrate.

### Advantageous Effects of Invention

According to the liquid crystal display apparatus of the present invention, by appropriately setting a relationship between the polarization direction of light from the surface light source device and the transmission axis direction of the back surface-side polarizing plate of the liquid crystal panel through use of the surface light source device configured to emit light having directivity and a polarization property, the light control layer capable of changing the scattering state of the light from the surface light source device, and the liquid crystal panel, a wide viewing angle and a narrow viewing angle can be satisfactorily switched even without using a louver film, and the viewing angle in a direction parallel to the array direction of light sources can be practically sufficiently narrowed at the time of narrow viewing angle setting.

### BRIEF DESCRIPTION OF DRAWINGS

FIG. 1 is a schematic sectional view of a liquid crystal display apparatus according to one embodiment of the present invention.

FIG. 2 is a schematic view for illustrating a relationship of a transmission axis direction (a) of a viewer-side polarizing plate, a transmission axis direction (b) of a back surface-side polarizing plate, and a vibration direction (c) of a linearly polarized light component contained in light emitted from a surface light source device 300 at a high ratio when the liquid crystal display apparatus illustrated in FIG. 1 is observed from a normal direction (Z direction).

FIG. 3 is a schematic sectional view for illustrating a light control layer that may be used in the liquid crystal display apparatus according to the one embodiment of the present invention.

FIG. 4 is a schematic view for illustrating a surface light source device that may be used in the liquid crystal display apparatus according to the one embodiment of the present invention.

FIG. 5 is a schematic perspective view for illustrating a prism sheet that may be used in the liquid crystal display apparatus according to the one embodiment of the present invention.

FIG. 6 are each a graph for showing (normalized) polar angle dependency of brightness in a vertical direction in liquid crystal display apparatus of Example 1 and Comparative Example 1.

FIG. 7 are each a graph for showing (normalized) polar angle dependency of brightness in a horizontal direction in the liquid crystal display apparatus of Example 1 and Comparative Example 1.

### DESCRIPTION OF EMBODIMENTS

Now, embodiments of the present invention are described with reference to the drawings, but the present invention is not limited to these embodiments. As used herein, a first transparent substrate and a second transparent substrate are sometimes collectively referred to as “transparent substrate”, and a first transparent electrode layer and a second transparent electrode layer are sometimes collectively referred to as “transparent electrode layer”. In addition, a laminate including the transparent substrate and the transparent electrode layer is sometimes referred to as “transparent conductive film”.

### Definitions of Terms and Symbols

The definitions of terms and symbols as used herein are as follows.

### (1) Refractive Index (nx, ny, nz)

“nx” represents a refractive index in a direction in which an in-plane refractive index is maximum (that is, a slow axis direction), “ny” represents a refractive index in a direction perpendicular to the slow axis in the plane, and “nz” represents a refractive index in a thickness direction.

### (2) Front Retardation Value

A front retardation value (Re[λ]) refers to an in-plane retardation value of a film at 23° C. and a wavelength λ (nm). Re[λ] is obtained by Re[λ]=(nx−ny)×d, where d (nm) represents the thickness of the film.

(3) The expression “substantially parallel” or “approximately parallel” as used herein includes a case of 0°±20° unless otherwise specified, preferably 0°±10°, more preferably 0°±5°.
(4) The expression “substantially perpendicular” or “approximately perpendicular” as used herein includes a case of 90°±20° unless otherwise specified, preferably 90°±10°, more preferably 90°±5°.
(5) Such a simple expression “perpendicular” or “parallel” as used herein may include a substantially perpendicular state or a substantially parallel state.

A. Overall Configuration of Liquid Crystal Display Apparatus

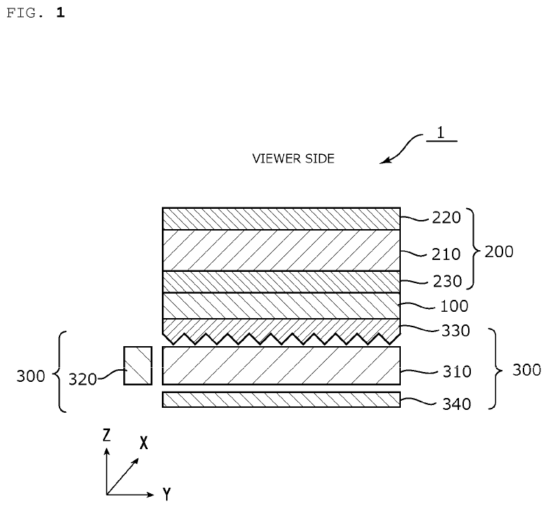

FIG. 1 is a view for illustrating a liquid crystal display apparatus 1 according to one embodiment of the present invention. The liquid crystal display apparatus 1 according to this embodiment includes in an order from a viewer side: a liquid crystal panel 200 including a liquid crystal cell 210, a viewer-side polarizing plate 220 arranged on the viewer side of the liquid crystal cell 210, and a back surface-side polarizing plate 230 arranged on an opposite side (back surface side) to the viewer side of the liquid crystal cell 210; a light control layer 100 configured to enable a scattering state of transmitted light to be changed; and a surface light source device 300 including a light source unit 320 and a light guide plate 310 configured to cause light from the light source unit 320 to enter from a side surface opposed to the light source unit 320, and to emit the light from a viewer-side surface opposed to the light control layer 100. In the illustrated example, the surface light source device 300 further includes a prism sheet 330 which is arranged on the viewer side of the light guide plate 310 and has convex portions on a back surface side and a reflecting plate 340 which is arranged on a back surface side of the light guide plate 310. Although description and the like are omitted, the liquid crystal display apparatus 1 includes, in addition to the above, devices, such as ordinary wiring, circuits, and members required for operating the liquid crystal display apparatus.

In the above-mentioned illustrated example, the liquid crystal panel 200, the light control layer 100, and the surface light source device 300 each have an approximately rectangular shape in plan view, and each have sides that are respectively parallel to the X direction and the Y direction perpendicular to each other. In this case, the emitting surface (display surface) of the liquid crystal display apparatus 1 is a plane parallel to the XY plane, and the direction vertical to the XY plane (Z direction) is a thickness direction.

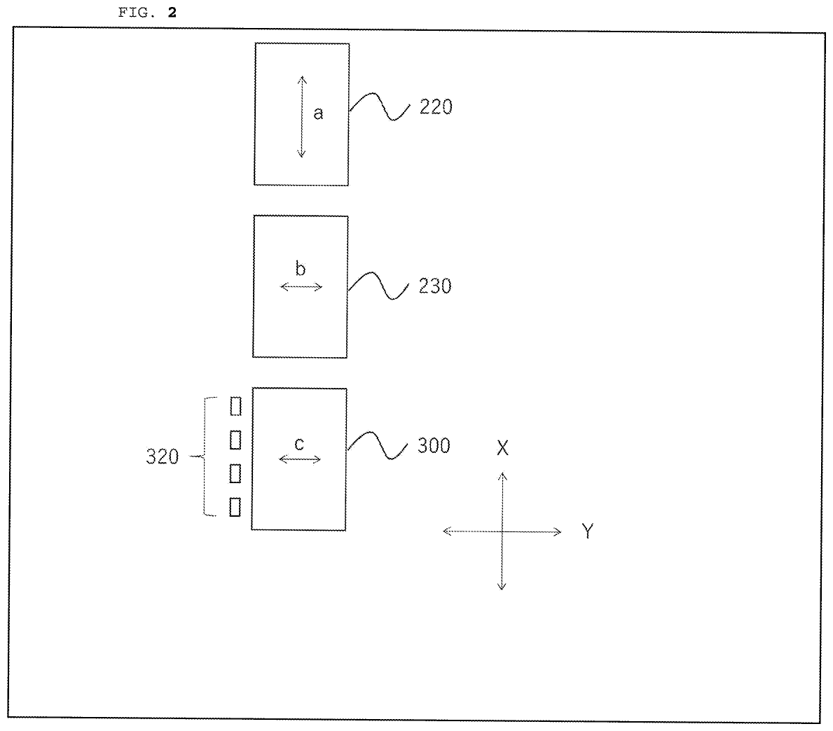

As described in the section D, the surface light source device 300 is configured to emit light which has directivity in an approximately normal direction of a viewer-side surface, and which contains a linearly polarized light component that vibrates in a plane approximately parallel to a light guide direction of light of the light guide plate at a high ratio. In the liquid crystal display apparatus 1, as illustrated in FIG. 2, the viewer-side polarizing plate 220 and the back surface-side polarizing plate 230 are arranged so that an angle formed by their respective transmission axis directions (arrow “a” direction and arrow “b” direction) is typically 90°±3.0°, preferably 90°±1.0°, more preferably 90°±0.5°, and so that the vibration direction (arrow “c” direction) of the linearly polarized light component contained in the light emitted from the surface light source device 300 at a high ratio is approximately parallel to the transmission axis (arrow “b” direction) of the back surface-side polarizing plate. With such configuration, a wide viewing angle and a narrow viewing angle can be satisfactorily switched by control of the scattering state of light through use of the light control layer 100, and further, the viewing angle in a direction (X direction) parallel to the array direction of light sources can be practically sufficiently narrowed at the time of narrow viewing angle setting. Unlike the illustrated example, the viewer-side polarizing plate 220 and the back surface-side polarizing plate 230 may be arranged so that the angle formed by their respective transmission axis directions (arrow “a” direction and arrow “b” direction) is typically 0°±3.0°, preferably 0°±1.0°, more preferably 0°±0.5°.

B. Liquid Crystal Panel

As described above, the liquid crystal panel typically includes the liquid crystal cell, the viewer-side polarizing plate, which is arranged on the viewer side of the liquid crystal cell, and the back surface-side polarizing plate, which is arranged on the back surface side of the liquid crystal cell.

The liquid crystal cell includes a pair of substrates and a liquid crystal layer as a display medium sandwiched between the substrates. In a general configuration, on one of the substrates, a color filter and a black matrix are arranged, and on the other substrate, there are arranged switching elements for controlling the electro-optical property of the liquid crystal, scanning lines for giving gate signals to the switching elements and signal lines for giving source signals thereto, and pixel electrodes and a counter electrode. An interval (cell gap) between the substrates may be controlled by spacers and the like. On sides of the substrates, which are brought into contact with the liquid crystal layer, for example, alignment films made of polyimide or the like may be formed.

In one embodiment, the liquid crystal layer includes liquid crystal molecules aligned in a homogeneous alignment under a state in which an electric field is not present. The liquid crystal layer (as a result, liquid crystal cell) as described above typically exhibits a three-dimensional refractive index of nx>ny=nz. Herein, ny=nz includes not only a case in which ny and nz are completely the same, but also a case in which ny and nz are substantially the same. As a typical example of a driving mode using the liquid crystal layer that exhibits the three-dimensional refractive index as described above, there are given, for example, an in-plane switching (IPS) mode and a fringe field switching (FFS) mode. The IPS mode includes a super in-plane switching (S-IPS) mode and an advanced super in-plane switching (AS-IPS) mode, each of which employs a V-shaped electrode, a zigzag electrode, or the like. In addition, the FFS mode includes an advanced fringe field switching (A-FFS) mode and a ultra fringe field switching (U-FFS) mode, each of which employs a V-shaped electrode, a zigzag electrode, or the like.

In another embodiment, the liquid crystal layer includes liquid crystal molecules aligned in a homeotropic alignment under a state in which no electric field is present. The liquid crystal layer (as a result, liquid crystal cell) as described above typically exhibits a three-dimensional refractive index of nz>nx=ny. As a driving mode using the liquid crystal molecules aligned in the homeotropic alignment under the state in which no electric field is present, there is given, for example, a vertical alignment (VA) mode. The VA mode includes a multi-domain VA (MVA) mode.

The viewer-side polarizing plate and the back surface-side polarizing plate each typically include a polarizer and a protective layer arranged on at least one side of the polarizer. The polarizer is typically an absorption-type polarizer.

The transmittance of the absorption-type polarizer (also referred to as single layer transmittance) at a wavelength of 589 nm is preferably 41% or more, more preferably 42% or more. The theoretical upper limit of the single layer transmittance is 50%. In addition, the polarization degree thereof is preferably from 99.5% to 100%, more preferably from 99.9% to 100%. As long as the polarization degree falls within the above-mentioned ranges, contrast in the front direction can be further increased when the polarizer is used in a liquid crystal display apparatus.

Any appropriate polarizer may be adopted as the polarizer. Examples thereof include a polarizer obtained by uniaxially stretching a hydrophilic polymer film such as a polyvinyl alcohol-based film, a partially formalized polyvinyl alcohol-based film, or an ethylene-vinyl acetate copolymer-based partially saponified film on which a dichroic substance, such as iodine or a dichroic dye, has been adsorbed, and a polyene-based alignment film, such as a product obtained by subjecting polyvinyl alcohol to dehydration treatment or a product obtained by subjecting polyvinyl chloride to dehydrochlorination treatment. Of those, a polarizer obtained by uniaxially stretching a polyvinyl alcohol-based film on which a dichroic substance, such as iodine, has been adsorbed is particularly preferred for its high polarized dichroic ratio. The thickness of the polarizer is preferably from 0.5 μm to 80 μm.

The polarizer obtained by uniaxially stretching a polyvinyl alcohol-based film on which iodine has been adsorbed is typically produced by: immersing polyvinyl alcohol-based film in an aqueous solution of iodine to dye the polyvinyl alcohol-based film; and stretching the dyed polyvinyl alcohol-based film so that the polyvinyl alcohol-based film has a length 3 times to 7 times as long as its original length. The stretching may be performed after the dyeing, the stretching may be performed while the dyeing is performed, or the dyeing may be performed after the stretching. The polarizer is produced through treatment, such as swelling, cross-linking, adjustment, water washing, or drying, in addition to the stretching and the dyeing.

Any appropriate film is used as the protective layer. Specific examples of a material serving as a main component of such film include: cellulose-based resins, such as triacetylcellulose (TAC); and transparent resins, such as a (meth)acrylic resin, a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, and an acetate-based resin. Another example thereof is a thermosetting resin or a UV-curable resin, such as an acrylic resin, a urethane-based resin, an acrylic urethane-based resin, an epoxy-based resin, or a silicone-based resin. Still another example thereof is a glassy polymer, such as a siloxane-based polymer. In addition, a polymer film described in JP 2001-343529 A (WO 01/37007 A1) may also be used. As a material for the film, for example, there may be used a resin composition containing a thermoplastic resin having a substituted or unsubstituted imide group in a side chain and a thermoplastic resin having a substituted or unsubstituted phenyl group and a nitrile group in a side chain. An example thereof is a resin composition containing an alternate copolymer formed of isobutene and N-methylmaleimide and an acrylonitrile-styrene copolymer. The polymer film may be, for example, an extruded product of the resin composition.

C. Light Control Layer

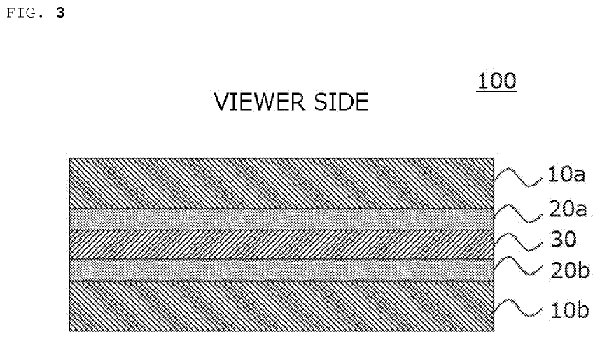

FIG. 3 is a schematic sectional view of the light control layer to be used in the liquid crystal display apparatus according to one embodiment of the present invention. The light control layer 100 includes a first transparent substrate 10a, a first transparent electrode layer 20a, a composite layer 30, a second transparent electrode layer 20b, and a second transparent substrate 10b in the stated order from the viewer side. Although not shown, refractive index adjusting layers may be formed between the first transparent substrate 10a and the first transparent electrode layer 20a and between the second transparent substrate 10b and the second transparent electrode layer 20b, respectively. In the same manner, an antireflection layer may be formed on an outer side of the first transparent substrate 10a (in other words, on an opposite side to a side on which the first transparent electrode layer 20a is arranged) and/or on an outer side of the second transparent substrate 10b (in other words, on an opposite side to a side on which the second transparent electrode layer 20b is arranged). Through formation of the refractive index adjusting layer and/or the antireflection layer, the light control layer having a high transmittance may be obtained.

The light control layer may have a haze of preferably 15% or less, more preferably 10% or less in a light transmitting state. When the haze in the light transmitting state falls within the above-mentioned ranges, light having directivity, which has entered from the back surface side, can be transmitted while maintaining the directivity thereof, and hence a narrow viewing angle can be suitably achieved.

The light control layer may have a haze of preferably 30% or more, more preferably from 50% to 99% in a light scattering state. When the haze in the light scattering state falls within the above-mentioned ranges, light having directivity, which has entered from the back surface side, is scattered, and hence a wide viewing angle can be suitably achieved.

As described later, the scattering state of the light transmitted through the light control layer (as a result, haze) changes depending on a voltage to be applied. Herein, the case in which the haze of the light control layer is a predetermined value or more (for example, 30% or more, preferably 50% or more) may be defined as the light scattering state, and the case in which the haze is less than the predetermined value (for example, 15% or less, preferably 10% or less) can be defined as the light transmitting state.

The light control layer has a parallel light transmittance of preferably from 80% to 99%, more preferably from 83% to 99% in the light transmitting state. When the parallel light transmittance in the light transmitting state falls within the above-mentioned ranges, light having directivity, which has entered from the back surface side, can be transmitted while the directivity is maintained. Therefore, a narrow viewing angle can be suitably achieved.

The light control layer has a total light transmittance of typically from 85% to 99% in the light transmitting state. In addition, the light control layer has a total light transmittance of preferably from 85% to 99%, more preferably from 88% to 99% in both the light transmitting state and the light scattering state. In the case where the total light transmittance falls within the above-mentioned ranges, even when the light control layer is incorporated into a high-definition liquid crystal display apparatus (for example, having a resolution of 150 ppi or more), a wide viewing angle and a narrow viewing angle can be switched while a decrease in brightness is suppressed.

The total thickness of the light control layer is, for example, from 50 μm to 250 μm, preferably from 80 μm to 200 μm.

In one embodiment, a front retardation Re[590] at a wavelength of 590 nm of each of the transparent substrates 10a and 10b may be 50 nm or less, preferably from 0 nm to 30 nm, more preferably from 0 nm to 20 nm. When the Re[590] of the transparent substrate is 50 nm or less, there is less display color unevenness, and the viewing angle can be narrowed at the time of narrow viewing angle setting.

In another embodiment, the front retardation Re[590] at a wavelength of 590 nm of each of the transparent substrates 10a and 10b may be more than 50 nm, for example, more than 50 nm and 50,000 nm or less. When the Re[590] of the transparent substrate is more than 50 nm, from the viewpoints of a narrow viewing angle and display color unevenness, it is preferred that the transparent substrate and the polarizing plate (for example, the viewer-side polarizing plate) of the liquid crystal panel be arranged so that the slow axis direction of the transparent substrate is substantially perpendicular or substantially parallel to the transmission axis direction of the polarizing plate. In addition, when both the Re[590] of the first transparent substrate and the Re[590] of the second transparent substrate are more than 50 nm, it is preferred that the first transparent substrate and the second transparent substrate be arranged so that the slow axis of the first transparent substrate is substantially perpendicular or substantially parallel to the slow axis of the second transparent substrate.

A material for forming the transparent substrate is typically a polymer film containing a thermoplastic resin as a main component. Examples of the thermoplastic resin include: a polyester-based resin; a cycloolefin-based resin, such as polynorbornene; an acrylic resin; a polycarbonate resin; and a cellulose-based resin. Of those, a polyester-based resin, a cycloolefin-based resin, or an acrylic resin is preferred. Those resins are each excellent in, for example, transparency, mechanical strength, thermal stability, and water barrier property. In addition, the cycloolefin-based resin is suitable as a material for the transparent substrate having a front retardation of 50 nm or less. The above-mentioned thermoplastic resins may be used alone or in combination thereof. In addition, an optical film to be used in a polarizing plate, for example, a low-retardation substrate, a high-retardation substrate, a retardation plate, or a brightness enhancement film may also be used.

The thickness of the transparent substrate is preferably 150 μm or less, more preferably from 5 μm to 100 μm, still more preferably from 20 μm to 80 μm.

The transparent electrode layer may be formed, for example, through use of a metal oxide, such as indium tin oxide (ITO), zinc oxide (ZnO), or tin oxide (SnO₂). Alternatively, the transparent electrode layer may be formed of a metal nanowire, such as a silver nanowire (AgNW), a carbon nanotube (CNT), an organic conductive film, a metal layer, or a laminate thereof. The transparent electrode layer may be patterned into a desired shape depending on the purpose.

The transparent electrode layer is typically formed through use of sputtering.

The composite layer typically contains a polymer matrix and a liquid crystal compound dispersed in the matrix. In the composite layer, the scattering state of transmitted light is changed by changing the degree of alignment of the liquid crystal compound corresponding to the application amount of a voltage, and with this, the light transmitting state and the light scattering state can be switched.

In one embodiment, the composite layer is in the light transmitting state at the time of application of a voltage, and the composite layer is in the light scattering state at the time of application of no voltage (normal mode). In this embodiment, the liquid crystal compound is not aligned at the time of application of no voltage, resulting in the light scattering state. When a voltage is applied, the liquid crystal compound is aligned, and the refractive index of the liquid crystal compound and the refractive index of the polymer matrix match with each other, resulting in the light transmitting state.

In another embodiment, the composite layer is in the light scattering state at the time of application of a voltage, and the composite layer is in the light transmitting state at the time of application of no voltage (reverse mode). In this embodiment, with an alignment film arranged on a surface of the transparent electrode layer, the liquid crystal compound is aligned at the time of application of no voltage, resulting in the light transmitting state. When a voltage is applied, the alignment of the liquid crystal compound is disturbed, resulting in the light scattering state.

Examples of the composite layer as described above include a composite layer containing a polymer-dispersed liquid crystal and a composite layer containing a polymer-network liquid crystal. The polymer-dispersed liquid crystal has a structure in which a liquid crystal compound in the form of droplets is dispersed in a polymer matrix. The polymer-network liquid crystal has a structure in which a liquid crystal compound is dispersed in a polymer network. The liquid crystal has a continuous phase in the polymer network.

As the liquid crystal compound, any appropriate liquid crystal compound of anon-polymeric type is used. The liquid crystal compound may have positive dielectric anisotropy or negative dielectric anisotropy. Examples of the liquid crystal compound may include nematic, smectic, and cholesteric liquid crystal compounds. A nematic liquid crystal compound is preferably used because excellent transparency can be achieved in the light transmitting state. Examples of the nematic liquid crystal compound include a biphenyl-based compound, a phenyl benzoate-based compound, a cyclohexylbenzene-based compound, an azoxybenzene-based compound, an azobenzene-based compound, an azomethine-based compound, a terphenyl-based compound, a biphenyl benzoate-based compound, a cyclohexylbiphenyl-based compound, a phenylpyridine-based compound, a cyclohexylpyrimidine-based compound, a cholesterol-based compound, and a fluorine-based compound.

A resin for forming the polymer matrix may be appropriately selected depending on, for example, the light transmittance and the refractive index of the liquid crystal compound. The resin may be an optically isotropic resin or may be an optically anisotropic resin. In one embodiment, the resin is an active energy ray-curable resin. For example, a liquid crystal polymer obtained by curing a polymerizable liquid crystal compound, a (meth)acrylic resin, a silicone-based resin, an epoxy-based resin, a fluorine-based resin, a polyester-based resin, and a polyimide resin may be preferably used.

The light control layer may be formed by any appropriate method. For example, a pair of transparent conductive films each including a transparent substrate, a transparent electrode layer formed on one side thereof, and a refractive index adjusting layer and/or an antireflection layer as required is prepared. A composition for forming a composite layer is applied onto the surface of the transparent electrode layer of one of the transparent conductive films, to thereby form an application layer. The other transparent conductive film is laminated on the application layer so that the transparent electrode layer is opposed to the application layer, to thereby form a laminate. The application layer is cured with an active energy ray or heat, thereby being capable of obtaining a light control layer. In this case, the composition for forming a composite layer contains, for example, a monomer (preferably, active energy ray-curable monomer) for forming a polymer matrix and a liquid crystal compound.

Alternatively, a resin for forming a polymer matrix and a liquid crystal compound are dissolved in a common solvent to prepare a solution for forming a composite layer, and the solution for forming a composite layer is applied onto the surface of the transparent electrode layer of the transparent conductive film similar to the above. A solvent is removed by drying to phase-separate the polymer matrix and the liquid crystal (solvent dry phase separation), to thereby form a composite layer. After that, another transparent conductive film is laminated on the composite layer so that the transparent electrode layer is opposed to the composite layer, thereby being capable of obtaining a light control layer. Instead of the solution for forming a composite layer, a liquid crystal emulsion liquid in which a liquid crystal compound is dispersed in a resin solution obtained by dissolving a polymer matrix resin in a solvent or an aqueous resin emulsion liquid obtained by emulsifying a polymer matrix resin may be used.

D. Surface Light Source Device

The surface light source device includes a light source unit and a light guide plate configured to cause light from the light source unit to enter from a side surface opposed to the light source unit, and to emit the light from a viewer-side surface opposed to a light control layer. The surface light source device is configured to emit light which has directivity in an approximately normal direction of the viewer-side surface, and which contains a linearly polarized light component that vibrates in a plane approximately parallel to a light guide direction of light of the light guide plate at a high ratio. When polarized light or partially polarized light having directivity is caused to enter the liquid crystal panel so that the vibration direction thereof (the vibration direction of the electric field) is parallel to the transmission axis of the back surface-side polarizing plate as described above, light use efficiency can be improved, and the viewing angle at the time of narrow viewing angle setting can be further narrowed. Herein, the expression “approximately normal direction” includes a direction within a predetermined angle with respect to the normal direction, for example, a direction within a range of ±10° with respect to the normal direction. In addition, the light “having directivity in an approximately normal direction” refers to light having an intensity distribution in which the peak of a maximum intensity of a brightness intensity distribution is in the approximately normal direction with respect to a light emitting surface in one plane perpendicular to the light emitting surface. For example, it is preferred that the brightness at a polar angle of 40° or more be 2% or less with respect to the brightness in the normal direction (polar angle: 0°), and it is more preferred that the brightness at a polar angle of 50° or more be 1% or less with respect to the brightness in the normal direction (polar angle: 0°). The polar angle refers to an angle formed by the normal direction (front direction) of the liquid crystal display apparatus and the emitted light from the liquid crystal display apparatus.

The light emitted from the surface light source device may contain the linearly polarized light component that vibrates in a plane approximately parallel to the light guide direction of light of the light guide plate at a ratio of preferably 52% or more, more preferably 55% or more. The upper limit of the ratio of the linearly polarized light component is ideally 100%, and may be 60% in one embodiment and 57% in another embodiment. The ratio of the linearly polarized light component in the light emitted from the surface light source device may be determined, for example, in accordance with a method described in JP 2013-190778 A.

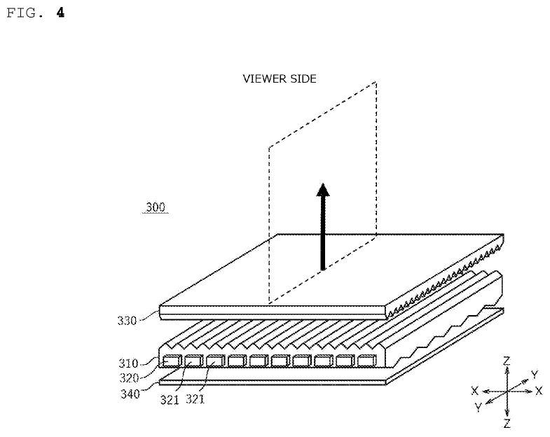

FIG. 4 is a schematic view for illustrating a surface light source device that may be used in the liquid crystal display apparatus according to one embodiment of the present invention. The surface light source device 300 illustrated in FIG. 4 includes the light guide plate 310 which is configured to cause light to enter from a side surface, and to emit the light from a viewer-side surface; the light source unit 320 which includes a plurality of point light sources 321 arranged at predetermined intervals along the side surface (light incident surface) of the light guide plate 310; the prism sheet 330 which is arranged on the viewer side of the light guide plate 310, and has convex portions on a back surface side; and the reflecting plate 340 which is arranged on the back surface side of the light guide plate 310. In the surface light source device 300, the light guide plate 310 is configured to deflect light from a lateral direction in a thickness direction, and to emit the light as light containing a linearly polarized light component that vibrates in a specific direction at a high ratio. The prism sheet 330 having the convex portions on the back surface side can bring the traveling direction of the light close to the normal direction of the light emitting surface without substantially changing the polarization state of the light.

In FIG. 4, when the direction perpendicular to the light guide direction of light of the light guide plate (array direction of the light sources) is defined as the X direction, the light guide direction of light of the light guide plate is defined as the Y direction, and the normal direction of the light emitting surface is defined as the Z direction, the surface light source device 300 emits light containing a linearly polarized light component (P-polarized light component) that vibrates in the YZ plane at a high ratio. When the light having directivity and containing the linearly polarized light component that vibrates in the YZ plane at a high ratio is caused to enter the liquid crystal panel with the vibration direction (Y direction) of the linearly polarized light component being matched with the transmission axis direction of the back surface-side polarizing plate, the viewing angle at the time of narrow viewing angle setting can be further narrowed as compared to the case of using a linearly polarized light component (S-polarized light component) that vibrates vertically to the YZ plane.

The light guide plate 310 is configured to cause, for example, light from the light source unit 320 to enter from the side surface (light incident surface) opposed to the light source unit 320, and to emit, from the viewer-side surface (light emitting surface), first directivity light which has directivity of maximum intensity in a first direction at a predetermined angle with respect to the normal direction of the light emitting surface in a plane approximately parallel to the light guide direction of light, and which is polarized light containing a polarized light component that vibrates in the plane at a high ratio. In the illustrated example, a columnar lens pattern is formed on each of the back surface side and the viewer side of the light guide plate. However, as long as desired light can be emitted, the lens pattern may be formed on only any one of the sides. In addition, the lens pattern is not limited to a columnar shape, and may be, for example, a pattern in which columnar, pyramidal, or hemispherical protrusions are dotted. In addition, the shape of the light guide plate is not particularly limited. For example, as illustrated in FIG. 2, the light guide plate has a principal surface having an approximately rectangular shape, and a side surface on a long side thereof is opposed to the light source unit.

The light source unit 320 is formed of, for example, the plurality of point light sources 321 arrayed along the side surface of the light guide plate. As the point light source, a light source configured to emit light having high directivity is preferred, and for example, an LED may be used.

The prism sheet 330 is configured to, for example, emit the second directivity light which has directivity in an approximately normal direction of the light emitting surface of the prism sheet 330 while substantially maintaining the polarization state of the first directivity light.

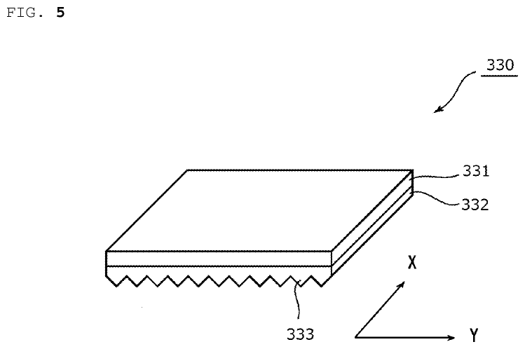

In the embodiment illustrated in FIG. 4 and FIG. 5, the prism sheet 330 includes a substrate portion 331 and a prism portion 332 in which a plurality of columnar unit prisms 333 that are convex toward the light guide plate 310 side are arrayed. The substrate portion 331 may be omitted depending on an adjacent member.

The prism sheet 330 may be bonded to the adjacent member via any appropriate adhesion layer (for example, an adhesive layer or a pressure-sensitive adhesive layer: not shown).

As described above, the prism portion 332 may be configured by arraying the plurality of unit prisms 333 that are convex toward an opposite side (back surface side) to the viewer side. When the unit prisms 333 are arranged toward the back surface side, light transmitted through the prism sheet 330 is easily condensed. In addition, when the unit prisms 333 are arranged toward the back surface side, there is less light that is reflected without entering the prism sheet 330 as compared to the case in which the unit prisms 333 are arranged toward the viewer side, with the result that a liquid crystal display apparatus having high brightness can be obtained.

The unit prisms each preferably have a columnar shape. The prism sheet in the illustrated example includes the plurality of columnar unit prisms each of which have a ridge line extending in the X direction, and are arrayed in the Y direction. The prism sheet is configured to condense transmitted light in the array direction Y of the unit prisms, that is, in a direction substantially perpendicular to the longitudinal direction (ridge line direction) X of the unit prisms. As the sectional shape of each of the unit prisms, any appropriate shape may be adopted as long as the effects of the present invention can be obtained. The unit prisms each may have a triangular shape in cross-section parallel to the array direction and parallel to the thickness direction (that is, the unit prisms each have a triangular prism shape), or another shape (for example, a shape in which one or both of inclined surfaces of each triangle has a plurality of flat surfaces with different inclination angles). The triangular shape may be a shape asymmetric with respect to a straight line which passes through the vertex of the unit prism and which is perpendicular to the sheet surface (for example, a scalene triangle), or a shape symmetric to the straight line (for example, an isosceles triangle). Further, the vertex of the unit prism may have a chamfered curved surface shape, or may be cut to have a flat surface at a tip to have a trapezoidal shape in cross-section. The detailed shape of the unit prism may be appropriately set in accordance with the purpose. For example, as the unit prism, the configuration described in JP 11-84111 A may be adopted. In the description of the unit prism, the expressions “substantially perpendicular” and “approximately perpendicular” include a case in which an angle formed by two directions is 90°±10°, preferably 90°±7°, more preferably 90°±5°. The expressions “substantially parallel” and “approximately parallel” include a case in which an angle formed by two directions is 0°±10°, preferably 0°±7°, more preferably 0°±5°.

Preferably, the longitudinal direction (ridge line direction) of the unit prisms is in an approximately perpendicular direction to the transmission axis of the back surface-side polarizing plate. The prism sheet may be arranged (so-called oblique arrangement) so that the ridge line direction of the unit prisms and the transmission axis of the back surface-side polarizing plate form a predetermined angle. The range of the angle in the oblique arrangement is preferably 20° or less, more preferably 15° or less.

When the substrate portion is formed on the prism sheet, the substrate portion and the prism portion may be integrally formed by subjecting a single material to extrusion molding or the like, or the prism portion may be molded on a film for a substrate portion. The thickness of the substrate portion is preferably from 25 μm to 150 μm.

As a material for forming the substrate portion, any appropriate material may be adopted in accordance with the purpose and the configuration of the prism sheet. When the prism portion is molded on a film for a substrate portion, specific examples of the film for a substrate portion include films each formed of triacetate cellulose (TAC), a (meth)acrylic resin, such as polymethyl methacrylate (PMMA), a polycarbonate (PC) resin, or a norbornene resin. The film is preferably an unstretched film.

When the substrate portion and the prism portion are integrally formed with a single material, there may be used, as the material, the same material as a material for forming a prism portion in the case of molding the prism portion on the film for a substrate portion. As the material for forming a prism portion, for example, there are given epoxy acrylate-based and urethane acrylate-based reactive resins (for example, ionizing radiation-curable resins). In the case of forming a prism sheet having an integrated configuration, a light-transmitting thermoplastic resin including a polyester resin, such as PC or PET, an acrylic resin, such as PMMA or MS, or cyclic polyolefin, may be used.

The substrate portion preferably has substantially optical isotropy. The expression “has substantially optical isotropy” as used herein means that the retardation value is small enough not to substantially influence the optical characteristics of the liquid crystal display apparatus. For example, the front retardation Re[590] of the substrate portion is preferably 20 nm or less, more preferably 10 nm or less.

In another embodiment, the front retardation Re[590] of the substrate portion may be more than 20 nm, for example, from 20 nm to 50,000 nm or less. When the Re[590] of the substrate portion is more than 20 nm, it is preferred that the substrate portion and the polarizing plate of the liquid crystal panel be arranged so that the slow axis direction of the substrate portion is substantially perpendicular or substantially parallel to the transmission axis direction of the polarizing plate of the liquid crystal panel from the viewpoints of a narrow viewing angle and display color unevenness.

Further, the photoelastic coefficient of the substrate portion is preferably from −10×10⁻¹² m²/N to 10×10⁻¹² m²/N, more preferably from −5×10⁻¹² m²/N to 5×10⁻¹² m²/N, still more preferably from −3×10⁻¹² m²/N to 3×10⁻¹² m²/N.

The reflecting plate 340 has a function of reflecting light released from the back surface side or the like of the light guide plate and returning the light into the light guide plate. As the reflecting plate, there may be used, for example, a sheet formed of a material having high reflectance, such as a metal (for example, a specularly reflective silver foil sheet or a thin metal plate having aluminum or the like vapor-deposited thereon), a sheet including a thin film (for example, a metal thin film) formed of a material having high reflectance as a surface layer (for example, a PET substrate having silver vapor-deposited thereon), a sheet having mirror reflectivity in which two or more kinds of thin films having different refractive indices are laminated as a multilayer, and a diffusely reflective white foamed polyethylene terephthalate (PET) sheet. As the reflecting plate, a reflecting plate that enables so-called mirror reflection is preferably used from the viewpoint of improving a light condensing property and light use efficiency.

For details of the light guide plate 310, the light source unit 320, and the prism sheet 330, for example, JP 2013-190778 A and JP 2013-190779 A may be referred to, the descriptions of which are incorporated herein by reference in their entirety.

In addition, the surface light source device which includes a light source unit and a light guide plate configured to cause light from the light source unit to enter from a side surface opposed to the light source unit, and to emit the light from a viewer-side surface opposed to the light control layer, and which is configured to emit light which has directivity in an approximately normal direction of the viewer-side surface, and which contains a linearly polarized light component that vibrates in a plane approximately parallel to a light guide direction of light of the light guide plate at a high ratio is not limited to the above-mentioned illustrated example, and any appropriate surface light source device may be used. For example, a surface light source device described in JP 09-54556A, or a surface light source device using, for example, a polarized light beam splitter or a polarized light conversion element (e.g., a device described in JP 2013-164434 A, JP 2005-11539 A, JP 2005-128363 A, JP 07-261122 A, JP 07-270792 A, JP 09-138406 A, or JP 2001-332115 A) may be used.

E. Production Method for Liquid Crystal Display Apparatus

The liquid crystal display apparatus may be produced, for example, by arranging optical members, such as a liquid crystal panel, a light control layer, and a surface light source device, in a housing so as to have a predetermined configuration. Typically, a surface light source device configured to emit light which has directivity in an approximately normal direction of a viewer-side surface, and which contains a linearly polarized light component that vibrates in a plane approximately parallel to a light guide direction of light of a light guide plate at a high ratio is arranged so that the vibration direction of the linearly polarized light component is parallel to the transmission axis of the back surface-side polarizing plate of the liquid crystal panel. With this, the improvement of light use efficiency and narrower viewing angle display can be achieved. Specifically, the surface light source device illustrated in FIG. 4 is preferably arranged so that the light guide direction of the light guide plate (Y direction) is parallel to the transmission axis of the back surface-side polarizing plate of the liquid crystal display panel.

In production of the liquid crystal display apparatus, the respective optical members may be arranged close to or in contact with each other without being bonded to each other via an adhesion layer. Alternatively, the adjacent optical members may be bonded to each other via the adhesion layer as required. The adhesion layer is typically an adhesive layer or a pressure-sensitive adhesive layer.

In one embodiment, a liquid crystal display apparatus may be obtained by arranging a light control layer on a viewer side of the surface light source device in advance to produce a backlight unit and arranging a liquid crystal panel on a viewer side (light control layer side) of the backlight unit.

In another embodiment, a liquid crystal display apparatus may be obtained by bonding a light control layer to a back surface side of a liquid crystal panel in advance to integrate the light control layer with the liquid crystal panel and arranging the surface light source device on a back surface side (light control layer side) of the liquid crystal panel integrated with the light control layer.

F. Display Characteristics of Liquid Crystal Display Apparatus

In one embodiment, in the liquid crystal display apparatus, at the time of narrow viewing angle setting, the brightness in an oblique direction is desirably less than 3%, more desirably less than 2%, still more desirably less than 1% with respect to the brightness in a front direction. For example, when, regarding the emitting surface (display screen) of the liquid crystal display apparatus, the direction parallel to the light guide direction of light of the light guide plate (Y direction of FIG. 1) is defined as the vertical direction, and the direction perpendicular to the light guide direction of light of the light guide plate (X direction of FIG. 1) is defined as the horizontal direction, it is preferred that the brightness at a polar angle of 40° or more be 2% or less with respect to the brightness in the front direction (polar angle: 0°) in any one or both of the horizontal and vertical directions within the emitting surface, and it is more preferred that the brightness at a polar angle of 50° or more be 1% or less with respect to the brightness in the front direction (polar angle: 0°) in the horizontal direction within the emitting surface. Meanwhile, at the time of wide viewing angle setting, the brightness at a polar angle of 40° is preferably 5% or more with respect to the brightness in the front direction, more preferably 2 or more and 20 or less times as large as that at the time of narrow viewing angle setting. When the brightness at the time of wide viewing angle setting falls within the above-mentioned ranges, it is possible to ensure practically acceptable visibility and wide viewing angle characteristics under a situation in which it is not required to consider peeping or the like.

G. Backlight Unit

A backlight unit includes the surface light source device. In one embodiment, the backlight unit has a configuration which further includes the light control layer and in which the light control layer is arranged on the light emitting surface side of the surface light source device. In this case, the light control layer may be bonded to the light emitting surface (for example, a viewer-side surface of a prism sheet) of the surface light source device via an adhesion layer.

### EXAMPLES

The present invention is specifically described below by way of Examples, but the present invention is not limited to these Examples. Test and evaluation methods in Examples are as described below. In addition, “parts” and “%” in Examples are weight-based units unless otherwise stated.

(1) Brightness

A white screen was displayed on a liquid crystal display apparatus obtained in each of Example and Comparative Example, and a brightness was measured through use of a brightness meter (manufactured by AUTRONIC-MELCHERS GmbH, product name “Conoscope”).

### (2) Front Retardation

A front retardation was measured at a wavelength of 590 nm and 23° C. through use of “AxoScan” (product name) manufactured by Axometrics.

### (3) Thickness

A thickness was measured through use of a digital micrometer (manufactured by Anritsu Corporation, product name “KC-351C”).

### Example 1

### (Light Control Layer)

On one surface of a cycloolefin-based transparent substrate (norbornene-based resin film (manufactured by Zeon Corporation, product name “ZF-16”), thickness: 40 μm, Re[590]: 5 nm), a transparent electrode layer (ITO layer) was formed by sputtering to obtain a transparent conductive film having a configuration of [COP substrate/transparent electrode layer].

An application liquid containing 40 parts of a liquid crystal compound (manufactured by HCCH, product name “HPC854600-100”) and 60 parts (solid content) of a UV-curable resin (manufactured by Norland, product name “NOA65”) were applied onto the surface of the first transparent conductive film on the transparent electrode layer side, to thereby form an application layer. Next, the second transparent conductive film was laminated on the application layer so that the transparent electrode layer was opposed to the application layer. The obtained laminate was irradiated with UV light to cure the UV-curable resin, to thereby obtain a light control layer A of a normal mode having a thickness of about 90 μm (configuration: first COP substrate/first transparent electrode layer/composite layer/second transparent electrode layer/second COP substrate).

(Liquid Crystal Panel)

A liquid crystal panel (configuration: viewer-side polarizing plate/liquid crystal cell of IPS mode/back surface-side polarizing plate) mounted on a notebook computer (manufactured by Dell, product name “Inspiron 13 7000”) was used.

(Surface Light Source Device)

A light guide plate, a plurality of LED light sources arranged at predetermined intervals along one side surface in a long side direction of the light guide plate, and a reflecting plate arranged on a back surface side of the light guide plate were removed from a notebook computer (manufactured by HP, product name “EliteBook x360”), and a prism sheet was arranged on a viewer side of the light guide plate so that a prism shape was convex toward the back surface side (in other words, the light guide plate side), to thereby produce a surface light source device as illustrated in FIG. 4. As the prism sheet, a prism sheet as illustrated in FIG. 4 and FIG. 5 was produced by filling a UV-curable urethane acrylate resin serving as a material for a prism into a predetermined mold through use of, as a substrate portion film, a stretched film (Re[590]: 6,000 nm) of a PET film (manufactured by Toyobo Co., Ltd., “A4300”, thickness: 100 μm) and irradiating the UV-curable urethane acrylate resin with UV light to cure the material for a prism on one surface of the substrate portion film. Each of unit prisms was a triangular prism, and a sectional shape thereof parallel to the array direction and parallel to the thickness direction was a scalene triangle. An angle formed by the ridge line of the prisms and the slow axis of the substrate portion film was 80°.

The obtained surface light source device was configured to emit, from a light emitting surface (viewer-side surface of the prism sheet), light which had directivity in an approximately normal direction of the light emitting surface and which contained a linearly polarized light component (P-polarized light component) that vibrated in a plane parallel to a light guide direction of light of the light guide plate (direction perpendicular to the array direction of the LED light sources) at a ratio of 56% or more.

(Liquid Crystal Display Apparatus)

The liquid crystal panel, the light control layer, and the surface light source device were arranged in the stated order from the viewer side to produce a liquid crystal display apparatus A. In this case, each member was arranged so that the transmission axis of the back surface-side polarizing plate of the liquid crystal panel and the vibration direction of the linearly polarized light component contained in the emitted light from the surface light source device at a ratio of 56% or more were parallel to each other.

### Comparative Example 1

A liquid crystal display apparatus B was produced by arranging the liquid crystal panel, the light control layer, and the surface light source device in the stated order from the viewer side in the same manner as in Example 1 except that each member was arranged so that the transmission axis direction of the back surface-side polarizing plate of the liquid crystal panel and the vibration direction of the linearly polarized light component contained in the emitted light from the surface light source device at a ratio of 56% or more were perpendicular to each other. In the liquid crystal display apparatus B, the vibration direction of the S-polarized light component and the transmission axis direction of the back surface-side polarizing plate of the liquid crystal panel are parallel to each other.

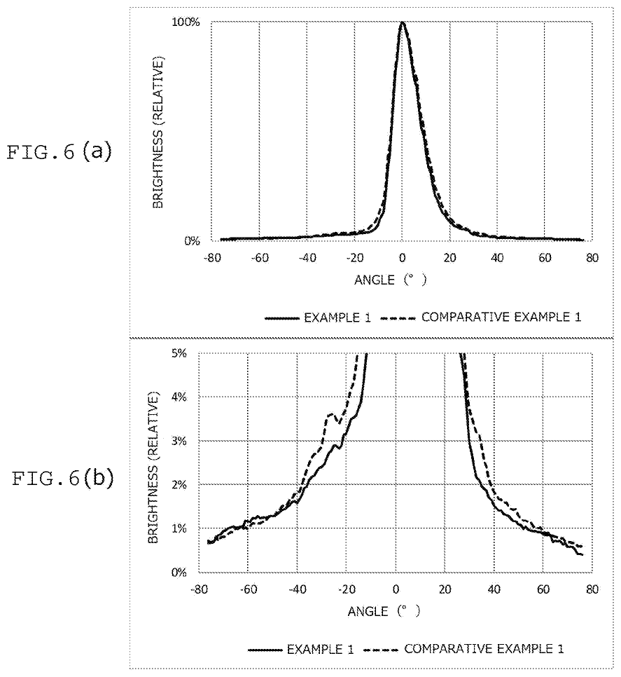

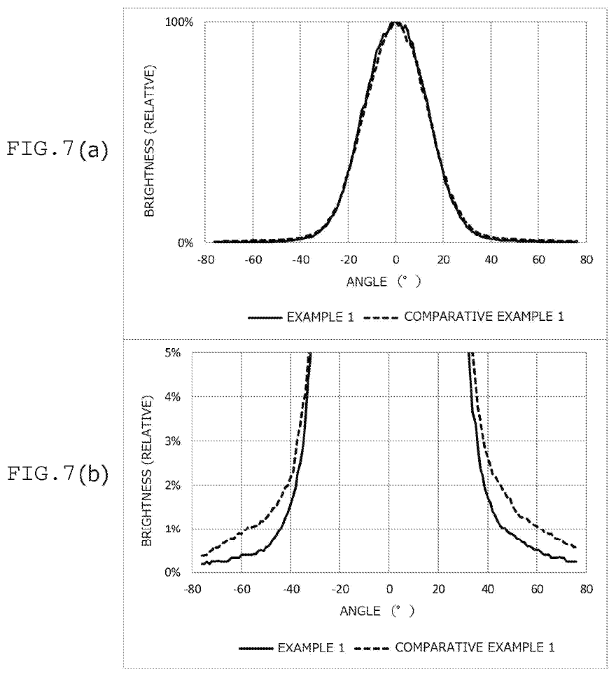

In each of the liquid crystal display apparatus obtained in Example and Comparative Example, the brightness on the display screen of the liquid crystal display apparatus at the time of narrow viewing angle setting was measured. Specifically, in FIG. 6, there is shown polar dependency of brightness in the vertical direction (Y direction in FIG. 1) when the brightness in a front direction (polar angle: 0°) at the time of application of a voltage of 100 V is set to 100%. In addition, in FIG. 7, there is shown polar angle dependency of brightness in the horizontal direction (X direction in FIG. 1) when the brightness in the front direction (polar angle: 0°) at the time of application of a voltage of 100 V is set to 100%. In each of FIG. 6 and FIG. 7, (b) is a view of enlarged main parts of (a).

As shown in FIG. 6 and FIG. 7, the liquid crystal display apparatus of Example 1 can achieve a viewing angle narrower than that of the liquid crystal display apparatus of Comparative Example 1 at the time of narrow viewing angle setting. In particular, viewing angle display in a direction (horizontal direction) parallel to the array direction of the LED light sources was at a level that had not hitherto been able to be achieved.

### REFERENCE SIGNS LIST

1 liquid crystal display apparatus
100 light control layer
200 liquid crystal panel
300 surface light source device
310 light guide plate
320 light source unit
330 prism sheet
340 reflecting plate

1. A liquid crystal display apparatus, comprising in an order from a viewer side:
a liquid crystal panel including a liquid crystal cell, a viewer-side polarizing plate arranged on the viewer side of the liquid crystal cell, and a back surface-side polarizing plate arranged on an opposite side to the viewer side of the liquid crystal cell;
a light control layer configured to enable a scattering state of transmitted light to be changed; and
a surface light source device including a light source unit and a light guide plate configured to cause light from the light source unit to enter from a side surface opposed to the light source unit, and to emit the light from a viewer-side surface opposed to the light control layer,
wherein the surface light source device is configured to emit light which has directivity in an approximately normal direction of the viewer-side surface, and which contains a linearly polarized light component that vibrates in a plane approximately parallel to a light guide direction of light of the light guide plate at a high ratio, and
wherein a vibration direction of the linearly polarized light component is approximately parallel to a transmission axis of the back surface-side polarizing plate.

2. The liquid crystal display apparatus according to claim 1, wherein a driving mode of the liquid crystal cell is an IPS mode or an FFS mode.

3. The liquid crystal display apparatus according to claim 1,
wherein the light control layer includes: a first transparent substrate; a first transparent electrode layer; a composite layer of a polymer matrix and a liquid crystal compound; a second transparent electrode layer; and a second transparent substrate in the stated order, and
wherein the first transparent substrate and the second transparent substrate are each formed of a material containing a cycloolefin-based resin.

4. The liquid crystal display apparatus according to claim 1,
wherein the light guide plate has a principal surface having an approximately rectangular shape, and
wherein the light guide plate has a side surface opposed to the light source unit, the side surface being a side surface on a long side.

5. The liquid crystal display apparatus according to claim 1,
wherein the light control layer includes: a first transparent substrate; a first transparent electrode layer; a composite layer of a polymer matrix and a liquid crystal compound; a second transparent electrode layer; and a second transparent substrate in the stated order,
wherein the first transparent substrate has a front retardation of 50 nm or less, and
wherein the second transparent substrate has a front retardation of 50 nm or less

6. The liquid crystal display apparatus according to claim 1,
wherein the light control layer includes: a first transparent substrate; a first transparent electrode layer; a composite layer of a polymer matrix and a liquid crystal compound; a second transparent electrode layer; and a second transparent substrate in the stated order,
wherein the first transparent substrate has a front retardation of more than 50 nm, and
wherein a slow axis of the first transparent substrate is substantially perpendicular or substantially parallel to a transmission axis of the viewer-side polarizing plate.

7. The liquid crystal display apparatus according to claim 6,
wherein the light control layer includes: a first transparent substrate; a first transparent electrode layer; a composite layer of a polymer matrix and a liquid crystal compound; a second transparent electrode layer; and a second transparent substrate in the stated order,
wherein the second transparent substrate has a front retardation of more than 50 nm, and
wherein a slow axis of the second transparent substrate is substantially perpendicular or substantially parallel to a transmission axis of the viewer-side polarizing plate.

8. The liquid crystal display apparatus according to claim 6,
wherein the first transparent substrate has a front retardation of more than 50 nm,
wherein the second transparent substrate has a front retardation of more than 50 nm, and
wherein the slow axis of the first transparent substrate is substantially perpendicular or substantially parallel to the slow axis of the second transparent substrate.
